(19) United States
(12) Patent Application Publication
(10) Pub. No.: US 2003/0233354 A1
(43) Pub. Date: Dec. 18, 2003

(54) System for mapping business technology

(76) Inventors: David M. White, McKinney, TX (US); Marianne G. Strong, Boxford, MA (US); John J. Moriarty, Concord, MA (US); Peter Dulchinos, Chelmsford, MA (US)

Correspondence Address: DALY, CROWLEY & MOFFORD, LLP, SUITE 101, 275 TURNPIKE STREET, CANTON, MA, 02021-2310, US

(21) Appl. No.: 10/459,260

(22) Filed: Jun. 11, 2003

Related U.S. Application Data
(60) Provisional application No. 60/388,254, filed on Jun. 13, 2002.

(51) Int. Cl. G06F 7/00

(52) U.S. Cl. 707/3

(57) ABSTRACT

A method and system for processing information, such as documents, for forming a business technology map having common variables, e.g., technology descriptors, for linking related technical and non-technical information.

### CROSS REFERENCE TO RELATED APPLICATIONS

The present application claims the benefit of U.S. Provisional Patent Application No. 60/388,254 filed on Jun. 13, 2002, which is incorporated herein by reference.

### STATEMENT REGARDING FEDERALLY SPONSORED RESEARCH

Not Applicable.

### FIELD OF THE INVENTION

This invention relates generally to information processing and, more particularly, to systems and methods for mapping business technology.

### BACKGROUND OF THE INVENTION

When managing and making decisions regarding intellectual property portfolios, it is often desirable to determine if a business entity has adequate patent coverage to protect current and future business interests and research areas. When considering a potential business decision, companies may attempt to evaluate the impact of the potential business decision, such as selling or licensing patents to a third party, by evaluating their patent portfolios relative to competitors' patent portfolios, identifying high profile technology areas within a company, and evaluating patented technology relative to the company's business plans. However, it can be challenging and time consuming for relatively large companies with significant technology and intellectual property interests to perform such an evaluation.

In addition, when determining where to direct valuable company resources in protecting intellectual property, such as selecting technologies for patenting, it can be difficult to quickly identify existing intellectual propery assets. Further, it may be relatively difficult to identify and share technical information across various business units and to classify intellectual property into groups related to technologies of interest.

There are a number of known methods that allow for the grouping of patents into various categories. Conventional patent portfolio management methods include the grouping of patents into mega-clusters, a procedure used by MAPIT (a system operated by Manning and Napier) that allows for a select group of patents to be grouped together based on similar terms and concepts. Further such grouping systems include Micropatent/Aurigin. Other conventional methods include the grouping of patents by art groups as done by the United States Patent and Trademark Office (USPTO) during the prosecution of a patent application. Patent grouping using the USPTO and/or International patent classification systems and subject classification systems can be performed by a company patent attorney, inventor, or other technologist.

Often the results obtained from these and other methods are overly broad or overly limiting in their classifications. In some conventional systems, the major focus is exploiting a patent portfolio. While a patent centric focus may present a comprehensive history of a company's technical development, such a focus may be of limited utility in evaluating potential business decisions.

It would, therefore, be desirable to overcome the aforesaid and other disadvantages.

### SUMMARY OF THE INVENTION

The present invention provides a system for mapping business technology data for various components of a business entity. With this arrangement, the business entity can readily survey its portfolio and evaluate the impact of potential business decisions across the business components. While the invention is primarily shown and described in conjunction with technical and non-technical intellectual property-related documents, it is understood that the invention is applicable to mapping various types of information across a range of entities having many possible structures.

In one embodiment, a method of mapping business technology data includes determining a plurality of technology descriptors, mapping technology documents to one or more of the technology descriptors, and determining which ones of the technology descriptors are of interest to each of a plurality of business segments. The method can further include displaying, in response to a query, information showing which of the business segments are interested in the various technology descriptors.

### BRIEF DESCRIPTION OF THE DRAWINGS

The foregoing features of this invention, as well as the invention itself, may be more fully understood from the following description of the drawings in which:

FIG. 1 is a block diagram of a system for mapping business technology in accordance with the present invention;

FIG. 1A is a block diagram of an exemplary business technology map database including a set of data sources according to the invention;

FIG. 2 is an exemplary Master Technology Descriptor List linking business segments to a technology map for multiple business segments according to the invention;

FIG. 3 is a portion of a template for an individual business segment based on the Master Technology Descriptor List of FIG. 2;

FIG. 3A is a portion of a completed business to technology map template for a segment and other related business entities according to the invention;

FIG. 4 is a portion of a business to technology map for multiple segments and related business entities according to the invention;

FIG. 5 is an exemplary list of technology description and corresponding codes according to the invention;

FIG. 6 is a patent and disclosure to technology code map for a corporate patent portfolio and invention disclosure list;

FIG. 7 is a business to point of contact map for a corporation according to the invention; and

FIG. 8 is a flow diagram illustrating the steps to map businesses to technology to patents and other corporate technical documents according to the invention.

### DETAILED DESCRIPTION OF THE INVENTION

Before providing a detailed description of the invention, it may be helpful to define some of the terms used in the description. As used herein, a “strategic technology” refers to technology that may be part of future business plans or technology of future interest to a business entity or a subset thereof. A “core technology” (also referred to as a tactical technology) refers to a technology which is important to a company's on going operations. Core business information and related non-technical documents include, but are not limited to, business program information, financial information, competitor assessments, marketing research, and in general any information which can be linked to a set of technology descriptions. In addition, it is understood that the term “document,” as used herein, should be construed broadly to include a wide range of information types and formats.

As used herein, a corporation or company includes a business entity having one or more segments each of which may have a plurality of business units. Each business unit further includes at least one business site. Each site is generally associated with a specific geographical location. It will be appreciated by those of ordinary skill in the art that a business can be organized in a variety of structures and that the technology descriptors as described below can be mapped to a wide range of business structures.

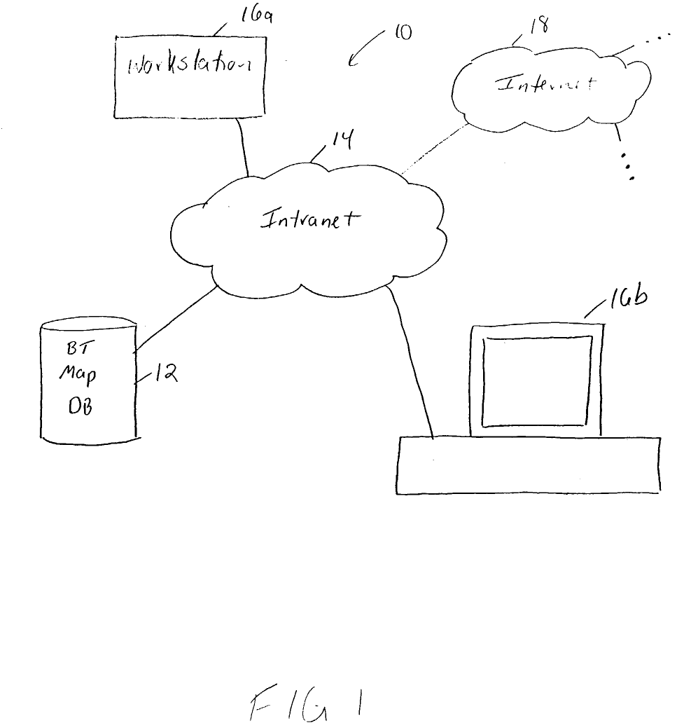

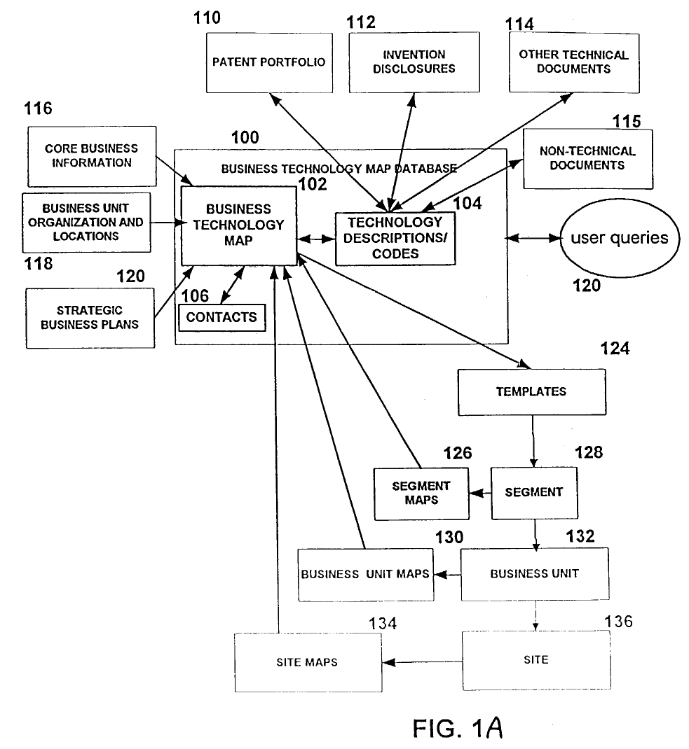

FIG. 1 shows an exemplary system 10 for mapping business technology in accordance with the present invention. The system 10 includes a database 12 containing various technical and non-technical business information, as described more fully below. In the illustrative embodiment, the database 12 is coupled to a company intranet 14 for enabling company users at workstations 16a,b to access the mapped information. In one embodiment, remote users can access the system 10 via the Internet 18. It will be readily apparent to one of ordinary skill in the art that a wide range of network arrangements are possible for the invention.

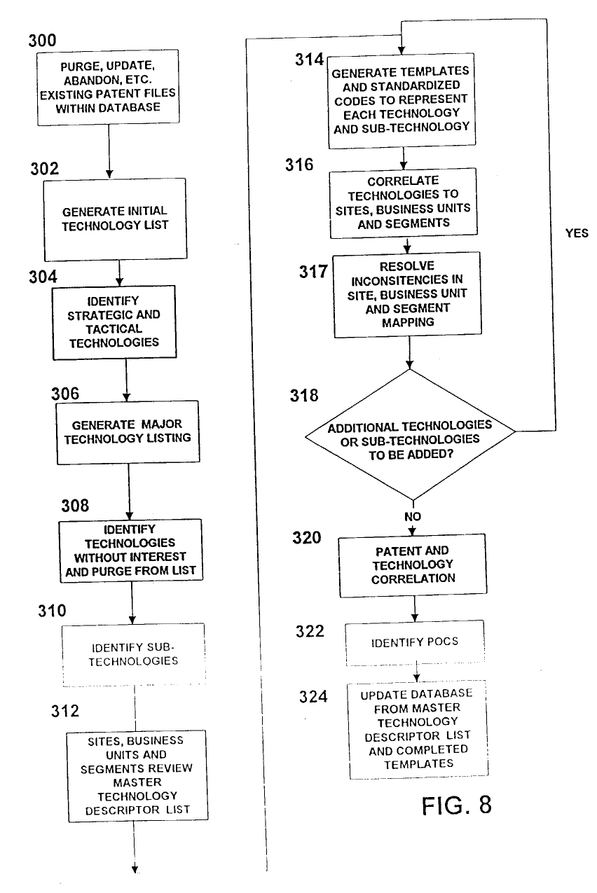

Now referring to FIG. 1A, an exemplary business technology map database 100 includes a business technology map 102 that is linked to a patent portfolio 110, invention disclosure system 112, other technical documents 114 and non-technical documents 115, through a set of technology descriptions/codes 104. The database 100 is also linked to a point of contact table (POC) 106. The business technology map 102 is initially formed by collecting core business information 116, business unit organization and locations 118, and strategic business plans 120 (as described in detail in conjunction with FIG. 8). The business technology map 102 and technology codes 104 are used to form templates 124 which are processed at the segment level 128 in the business organization to provide segment maps 126, as described below. The templates are further processed at the business unit level 132 to provide unit maps 130, and at the site level 136, to provide site maps 134. The segment maps 126, the unit maps 130, and the site maps 134 are used to augment the business technology map 102.

The database 100 provides data reflecting the relationship of business technologies and the patent portfolio elements 110, invention disclosures 112, other technical documents 114 and non-technical documents 115 in response to a user query 120. Other technical documents 114 can include, for example, technical reports, published papers, product specifications, manufacturing information, bids and proposals. Non-technical documents 115 include, for example, personnel records, marketing information, program management documents, and other documents which although not including technology phrases can be linked to technology descriptions.

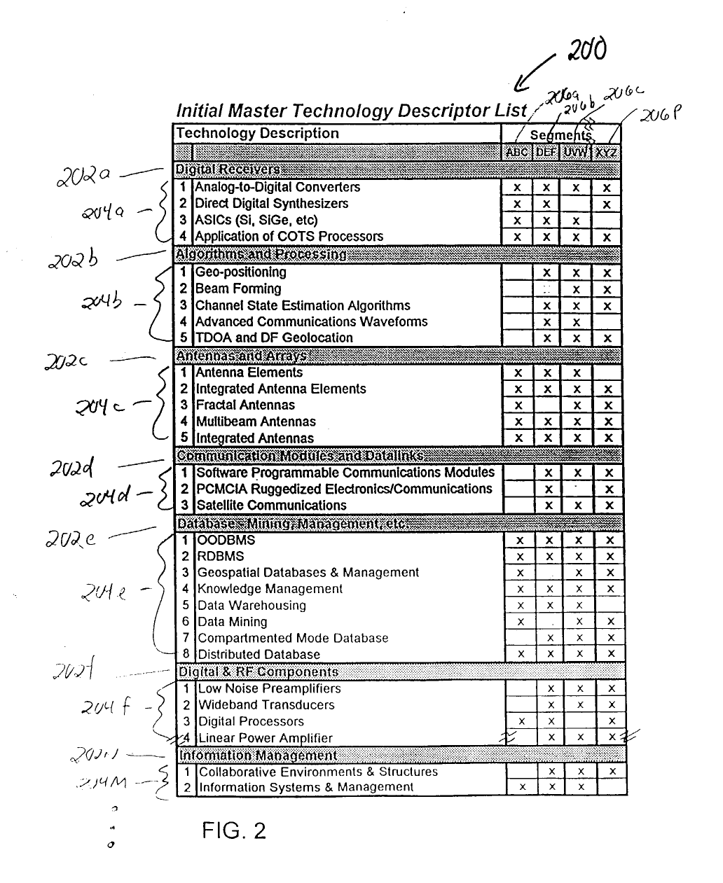

Now referring to FIG. 2, an exemplary Master Technology Descriptor List 200 includes a plurality of rows 202a-N each identifying a technology description, which reflects the core and strategic technology areas of a company. Each technology description 202 can further include subsets 204a-M for further defining the technology areas. It is understood that the subsets 204 can include further subsets and so on.

The Master Technology Descriptor List 200 further includes a series of columns 206a-P which identify specific business segments within the company. In one particular embodiment, a series of “X”s are used to map the technology descriptors 202, 204 to each segment 206 in the company. It will be appreciated by those of ordinary skill in the art that the Master Technology Descriptor List 200 can be provided as either an electronic document or as a hard copy document and that a variety of formats can be used to collect the technology to business mapping.

The Master Technology Descriptor List 200 can contain an identification of the core and strategic technologies of a company through the technology descriptors 202 and subsets 204. For example, core and strategic technologies can be differentiated when displayed in a variety of ways, including color coding, symbols and the like. In one embodiment, after the Master Technology Descriptor List 200 is distributed to the various business segments in the company, the selected technologies are marked by “X”s for each segment to provide a means for identifying which business segments are currently developing or have an interest in developing the predetermined technologies. It will be readily appreciated by one skilled in the art that various indicators other than an “X” can be used to select technologies. When all the major technologies and sub-technologies have been determined, the Master Technology Descriptor List 200 becomes a template for collecting the same information for each of the company's other business organizations.

The technical and business community within each of the company's businesses is one source that can be used to compile information relative to the company's core and strategic technology areas for their business. Once this information is collected either manually, automatically, or using a combination of methods, a list of terms that broadly identifies technology areas within each business is compiled and each of these broad technology areas is then divided into various subsets that further describe the technologies within each broad category, as described above. Prior to becoming recorded, the list of technology descriptions may be technically reviewed, along with any suggested additions, by representatives of each business entity and/or technologists for accuracy and completeness. The Master Technology Descriptor List 200 provides the selected technology descriptions as the common link between the company's core and strategic technology areas and multiple sets of cross-related information.

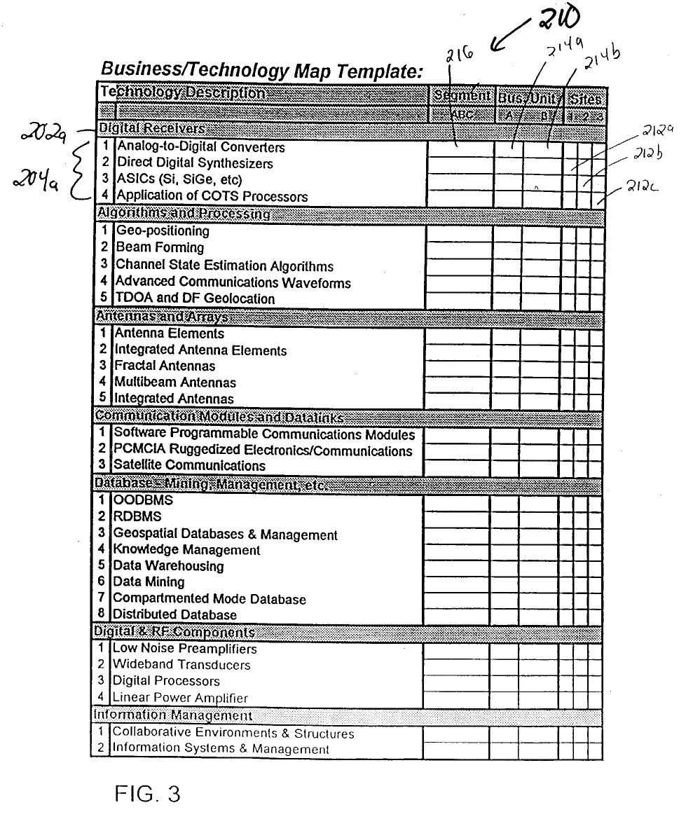

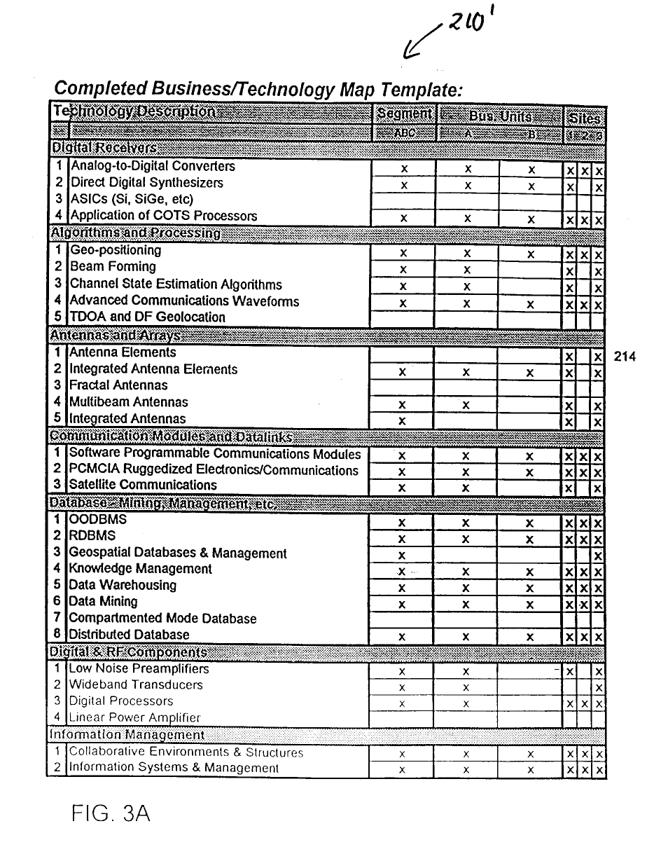

Now referring to FIG. 3, a business/technology map template 210 includes the technology descriptors 202 and subsets 204 of the Master Technology Descriptor List 200 of FIG. 2, and further includes a series of columns for sites 212a,b,c, business units 214a,b and business segment 216 within a company. It is understood that the number of sites and business units will reflect an actual business segment, which can include any number of sites and business units. The template 210 is used to collect information indicating where the core and strategic technologies fit within the company's business entities.

The templates derived from the technology description/codes list are used for collecting, organizing and formatting other cross-related data, thereby providing a means to link data through a common variable for providing a quick overview of other sets of cross-related information. In one embodiment, the template 210 is used as a form on which a series of “X”s are used to map the technology descriptors to each of the business units and sites which here are further business divisions of a business segment.

Now referring to FIG. 3A, a portion of a completed template 210′ is similar to template 210 (FIG. 3) is shown. Here, the completed template 210′ includes a series of “X”s that are used to map the technology descriptors to each of the business units and sites which here are further business divisions of a business segment. Inconsistencies can occur, for example, at row 214 where sites 1 and 3 indicate an interest in antenna elements which is not reflected in the corresponding business unit or segment. Such inconsistencies can be resolved by the process for forming the business to technology map database 100 (as described in conjunction with FIG. 8).

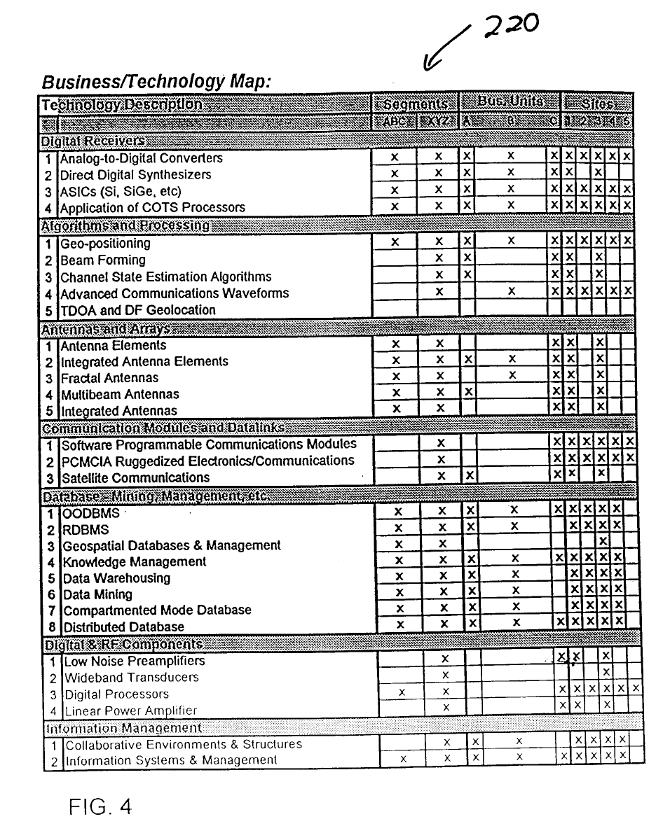

Now referring to FIG. 4, a portion of an exemplary business to technology map 220 for multiple business segments includes data from a plurality of completed templates 210′ (FIG. 3A) after being completed by each site for a plurality of segments in a company. It will be appreciated by those of ordinary skill in the art that the map 220 can be iteratively updated. For example, if a business site determines that a technology of interest is not reflected on the template 210 (FIG. 3), the template 210 is updated and is eventually circulated to all of the sites where it is again updated to reflect any interest in the added technology.

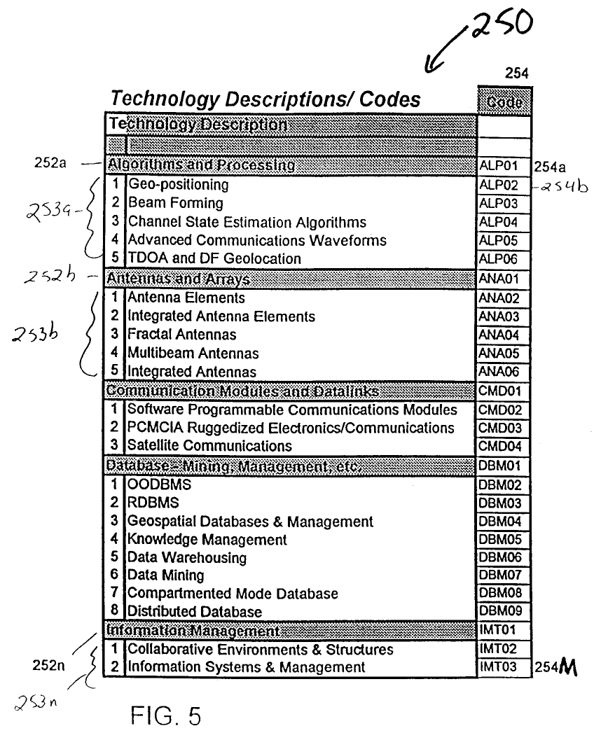

FIG. 5 shows a portion of an exemplary technology description/code list 250 including a list of technology descriptions 252a-N and subsets 253a-N and corresponding technology codes 254a-M (generally referred to as technology codes 254). The technology description/codes list 250 provides an alphanumeric system used to code the predetermined technology descriptions as they relate to the company's core and strategic businesses. In one embodiment, an “alpha” symbol is taken from the first letter of each word in the title assigned to the broad technology groups. A “numeric” value is then assigned to the subsets of technology descriptions within each broad technology group. The codes of technology description/codes list 250 provide a means to link multiple sets of cross-related business and technology information.

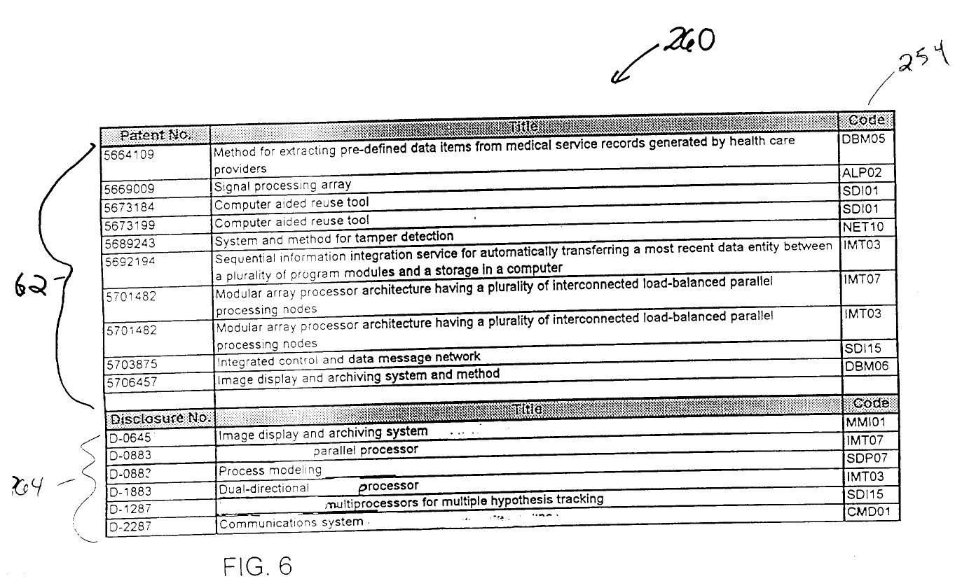

Now referring to FIG. 6, an exemplary technology document to technology code correlation list 260 includes a set of the U.S. patents 262 currently owned by or of interest to the company. The technology document to technology code correlation list 260 can further include invention disclosures 264 and other technical documents which can be mapped to a technology through the codes 254. In one embodiment, a code 254, here in alphanumeric format, from technology description/codes list 250 (FIG. 5) is assigned to each patent.

In one embodiment, the list of patents is compiled from an internal docketing database, which identifies those patents currently owned by the company. In an alternate embodiment, an automated system can be used to generate this list from a variety of patent database sources. Using techniques known in the art, the Master Technology Descriptor List 200, completed templates 210 (FIG. 3), technology description/codes list 250 (FIG. 5) and the technology document to technology code correlation list 260 provide a database having tables which can relate a company's businesses, a-set of relevant technology descriptions and patented technologies and other technical and non-technical documents.

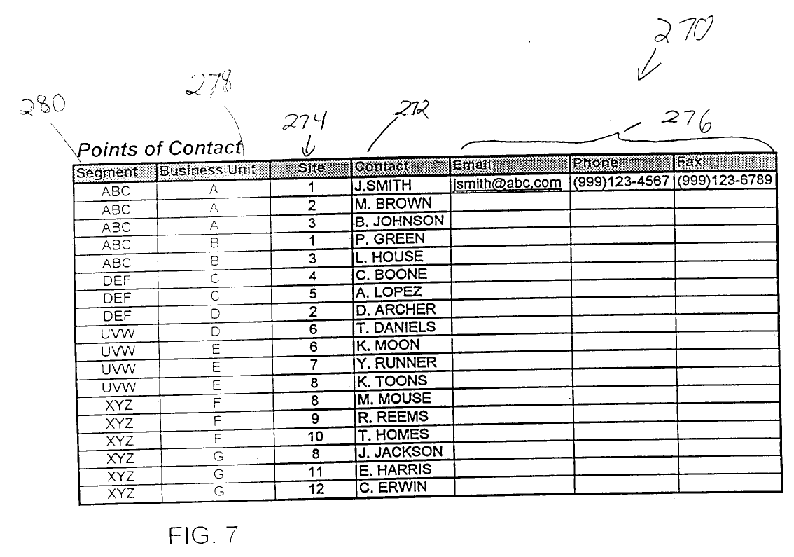

Now referring to FIG. 7, an exemplary points of contact list 270 includes a contact column 272 having at least one individual to contact at each site 274 along with contact information 276 and organization information, such as the corresponding business unit 278 and segment information 280. Preferably, the point of contact for each site is familiar with the technologies at each respective site.

Referring now to FIG. 8, a flow diagram illustrates a process for mapping a company's businesses to technology to patents and other corporate technical documents. In the flow diagrams of FIG. 8, the rectangular elements are herein denoted “processing blocks” (typified by element 302) and can represent computer software instructions or groups of manual procedures. The diamond shaped elements in the flow diagrams are herein denoted “decision blocks” (typified by element 318) and can represent computer software instructions or groups of procedures which affect the operation of the processing blocks. Alternatively, the processing blocks represent steps performed by functionally equivalent manual operations. It will be appreciated by those of ordinary skill in the art that some of the steps described in the flow diagrams may be implemented via computer software while others may be implemented in a different manner (e.g. via manual procedures or interactive systems). The flow diagrams do not depict the syntax of any particular programming language. Rather, the flow diagrams illustrate the functional information used to generate computer software to perform the required processing. It should be noted that many routine program elements, such as initialization of loops and variables and the use of temporary variables, are not shown. It will be appreciated by those of ordinary skill in the art that unless otherwise indicated herein, the particular sequence of steps described is illustrative only and can be varied without departing from the spirit of the invention.

In the process described by FIG. 8, a Master Technology Descriptor List 200 (FIG. 2), completed templates 210′ (FIG. 3A), technology description/codes list 250 (FIG. 5), a technology document to technology code correlation list 260 (FIG. 6) and a points of contact list 270 (FIG. 7) are compiled. The Master Technology Descriptor List 200 which includes the list of technology descriptions serves as a template for collecting data related to various business groups within the company. The template 210′ identifies the type of information to collect and the organization of that information, and provides a link between business entities within a company to technical and non-technical information and documents through a carefully chosen set of technology descriptions. The process for collecting data used to compile the Master Technology Descriptor List 200 and for completing the templates is explained below.

The business-technology-patent mapping process begins at step 300, where the patent portfolio and/or invention disclosures are updated to remove abandoned or otherwise expired patents, closed matters, and patents and disclosures which are no longer of interest, no longer owned or are not related to the company's core and strategic technologies.

At step 302, an initial technology list is generated. Sources of technology terms can be provided by existing business technology listings, USPTO Classes & Subclasses, Standard Industry Classifications (SIC), Defense Technical Information Center (DTIC) standards, governmental report categories and other commercially available industry listings, as well as company-generated terms. In one embodiment this step is an iterative process relying, for example, on interviews, questionnaires, etc. to determine core and strategic technologies of interest throughout the company.

At step 304, the core and strategic technologies are identified at each site, each business unit, each segment for the overall company. It should be understood that the number of technologies could vary with the size of company. At step 306, a major technology listing is generated based on findings from the core and strategic technology categories determined in step 304. Table 1 below includes examples of some major technology areas in an exemplary major technology listing.

TABLE 1

Major Technology List
Electronically Scanned Arrays
Sensors and Focal Plane Arrays
Algorithms and Processing
Systems - Design & Integration
Acoustics
Antennas and Arrays
Communication Modules and Datalinks
Database - Mining, Management, etc.
Digital & RF Components
Microelectronic/Electronic Packaging & Cooling
Information Management
Networks
Sensor & Data Processing
Simulation, Modeling & Analysis
Structures & Materials
Man-Machine Interface & Human Computer Interface
Power Systems

At step 308, technologies in which the company does not have an interest are identified and purged from the major technology list. Additionally any gaps in technology coverage are identified and filled in by adding the missing technology descriptions to the major technology list. At step 310, sub-technologies are identified for each major technology further delineating specific initiatives based on information obtained from step 304 above. A predetermined maximum number of sub-technologies can be set for each major technology.

At step 310, sub-technologies are identified and added to the major technology list to form an initial Technology Descriptor List based on findings from the core and strategic technologies identified in step 304. In one embodiment, raw data is collected from various internal sources such as the patent department, the business development groups and technology community. The data collected includes, but is not limited to, the identification of the company's core and strategic technology areas and the company's businesses, which are further broken down by business units, and geographic location. In one embodiment, “X”s placed on a form at the intersection of a technology description and a business segment identify those business segments that have an interest in a particular technology area. The raw data is then compiled to generate the Master Technology Descriptor List 200, which serves as a template for mapping each of the company's businesses to a predetermined group of technology descriptions that identify core and strategic technology areas across company lines.

At step 312, the Master Technology Descriptor List 200 can optionally be reviewed by technical contacts at the various business entities to ensure coverage of selected technologies and the overall business objectives of the sites, business units, and segments as well as the corporate level.

At step 314, templates including standardized codes are generated to represent each technology and sub-technology for correlation with other database information and other databases. At step 316, the core and strategic business interests and initiatives of each site, business unit and segment are correlated to the technology descriptions as provided in the template.

At step 317, any inconsistencies among the selected technology descriptions of site, business unit and segment are resolved by adding or deleting a technology. An inconsistency can occur, for example, where a site is interested in a particular technology and the segment containing the site is unaware of this interest. Any errors in completing the template are also detected and resolved in this step.

At step 318, it is determined whether any additional major technologies or sub-technologies have been identified as the result of activities in step 316. If there are additional technologies processing continues at step 314 to generate additional standardized codes and to update the templates which are then reprocessed at step 316. If there are no further technologies or sub-technologies to be added processing continues at step 320.

At step 320, patents, invention disclosures and other technical and non-technical documents are correlated to the technology descriptions via the standardized technology codes 254 (FIG. 5) by assigning the technology codes 254 to each document. It should be noted that more than one code might be applicable to each patent depending on the level of granularity in the major and sub technology listings.

At step 322, a point of contact (POC) is identified at each site. The POC may be, for example an attorney, a patent agent, a patent engineer or a technical lead who assists with coordination of all IP activities.

At step 324, the business technology map 100 (FIG. 1) is updated from the completed master lists. The mapping provides the company with a database having a set of common technology descriptions that allows a quick overview of the company's core and strategic (present and future) business interests and the company's technology including but not limited to its intellectual property including patents and invention disclosures.

It will be appreciated by those of ordinary skill in the art that several of the above steps can be automated and the process can be integrated with other enterprise systems such as docketing database systems, financial systems, licensing support systems for example, commercial systems such as: Omnis, Aurigin, and CaseTrack.

In one particular embodiment, core technologies are displayed in red font and strategic technologies are displayed in blue font. Further embodiments differentiating between core and strategic technologies will be readily apparent to one of ordinary skill in the art including symbols, such as letters (e.g., c and s), font differences, and the like. One of ordinary skill in the art will also appreciated that the information can be displayed in a wide range of formats including multiple overlapping windows displayed on the screen.

The present invention provides a system for generating a business technology map/database that can be used to collect a wide range of information about a company's technologies and intellectual property relative to its businesses. The map/database provides a means for sharing technical information across company lines, a means for classifying a company's patents into groups of predetermined technology descriptions that identify a company's core and strategic technology areas. The map/database provides a means for analyzing business decisions that may impact a company's businesses through the selling or licensing of patents to a third party, evaluating a company's patent portfolio relative to a competitor's patent portfolio, a means of identifying high profile technology areas within a company, and a means of evaluating the company's patented technology relative to its businesses.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims. All publications and references cited herein are expressly incorporated herein by reference in their entirety.

What is claimed is:

1. A method of processing business technology data, comprising:
determining a plurality of technology descriptors;
mapping technology documents to one or more of the technology descriptors;
determining which ones of the technology descriptors are of interest to each business segment of a plurality of business segments, and
displaying, in response to a query, information showing first ones of the plurality of business segments interested in first ones of the technology descriptors.

2. The method according to claim 1, further including displaying, in response to a query, information showing which ones of the documents are mapped to the first ones of the technology descriptors.

3. The method according to claim 1, wherein the documents include one or more of patents and invention disclosure documents.

4. The method according to claim 3, wherein the documents include one or more of program management documents, personnel records, competitor information, and marketing information.

5. The method according to claim 1, further including determining sub-categories for the technology descriptors.

6. The method according to claim 1, further including determining for a first one of the plurality of business segments associated business units and/or sites.

7. The method according to claim 1, further including determining which of the documents are associated with a core technology and which of the documents are associated with a strategic technology.

8. The method according to claim 1, further including displaying a technology descriptor list.

9. The method according to claim 1, further including displaying a business/technology map.

10. The method according to claim 1, further including determining codes for each of the plurality of technology descriptor codes.

11. The method according to claim 10, further including displaying documents associated with a first one of the technology descriptor codes.

12. The method according to claim 1, further including displaying contact information for a first one of the plurality of business segments.

13. A computer-readable medium comprising code for enabling a computer to process business technology data by performing the steps of:
receiving a plurality of technology descriptors;
mapping documents to one or more of the technology descriptors;
receiving a determination of which ones of the technology descriptors are of interest to each business segment of a plurality of business segments, and
displaying, in response to a query, information showing first ones of the plurality of business segments interested in first ones of the technology descriptors.

14. The medium according to claim 13, further including code for displaying, in response to a query, information showing which ones of the documents are mapped to the first ones of the technology descriptors.

15. The medium according to claim 13, wherein the documents include one or more of patents and invention disclosure documents.

16. The medium according to claim 15, wherein the documents include one or more of program management documents, personnel records, competitor information, and marketing information.

17. The medium according to claim 13, further including code for receiving sub-categories for the technology descriptors.

18. The medium according to claim 13, further including code for receiving a determination of business units and/or sites associated with a first one of the plurality of business segments.

19. The medium according to claim 13, further including code for receiving a determination of which of the documents are associated with a core technology and which of the documents are associated with a strategic technology.

20. The medium according to claim 13, further including code for displaying a technology descriptor list.

21. The medium according to claim 13, further including code for displaying a business/technology map.

22. The medium according to claim 13, further including code for receiving a determination of codes for each of the plurality of technology descriptor codes.

23. The medium according to claim 22, further including code for displaying documents associated with a first one of the technology descriptor codes.

24. The medium according to claim 13, further including code for displaying contact information for a first one of the plurality of business segments.

25. A system for mapping business technology data, comprising:
a module for receiving technology descriptors;
a module for mapping documents to one or more of the technology descriptors;
a module for receiving information including which ones of the plurality of technology descriptors are of interest to each business segment of a plurality of business segments; and
a module for displaying, in response to a query, information showing first ones of the plurality of business segments interested in first ones of the technology descriptors.

26. The system according to claim 25, wherein each of the plurality of business segments can include one or more business units and/or one or more business sites.

27. The system according to claim 25, wherein the technology descriptors can have subcategories.

28. The system according to claim 25, wherein the module for displaying can further display first ones of the documents associated with a first one of the technology descriptors.

29. A method for enabling mapping of business technology data comprising:
generating a module for receiving a plurality of technology descriptors;
generating a module for storing the plurality of technology descriptors;
generating a module for mapping documents to one or more of the technology descriptors;
generating a module for receiving information including which ones of the technology descriptors are of interest to each business segment of a plurality of business segments; and
generating a module for displaying, in response to a query, information showing first ones of the plurality of business segments are interested in first ones of the technology descriptors.

30. A method of processing business technology data, comprising:
providing an initial technology list;
identifying strategic technologies from at least one business objective and the initial technology list to generate a list of major technologies;
providing a technology list by determining at least one sub-technology for at least one of the technologies on the list of major technologies;
generating a standardized code for each of the plurality of major technologies and each of the plurality of sub-technologies listed hereunder;
providing the technology list to each of a plurality of business sites as a template for indicating at least one technology required to fulfill at least one business objective at each of the plurality of business sites;
correlating each of the technologies on the technology list with the at least one technology required to fulfill the at least one business objective at each of the plurality of business sites; and
correlating the technology list with each of a plurality of technical documents.
